(19) United States
(12) Patent Application Publication
(10) Pub. No.: US 2026/0220746 A1
(43) Pub. Date: Jul. 30, 2026

(54) NOISE ADJUSTMENT TECHNIQUES FOR PROCESSED IMAGES

(71) Applicant: QUALCOMM Incorporated, San Diego, CA (US)

(72) Inventors: Yuqi Ding, Santee, CA (US); Narayana Karthik Ravirala, San Diego, CA (US); Jeevitha Gowda Chandramouli, San Diego, CA (US)

(21) Appl. No.: 19/040,404

(22) Filed: Jan. 29, 2025

(51) Int. Cl. G06T 5/70; G06V 10/60

(52) U.S. Cl. CPC G06T 5/70; G06V 10/60; G06T 2207/20221

(57) ABSTRACT

This disclosure provides systems, methods, and devices that enhance image processing by reintroducing adjusted residual signals to improve image quality, particularly in low-light conditions. In one aspect, a method is provided that includes receiving a plurality of image frames and determining a first image and a map based on at least a subset of these frames. The method involves reducing noise in the first image to produce a second image and calculating a residual signal based on the first and second images. The residual signal may then be adjusted based on the map and combined with the second image to produce an output image. Other aspects and features are also claimed and described. For example, a scaling factor may be determined and the adjusted residual signal may be scaled by this factor.

### TECHNICAL FIELD

Aspects of the present disclosure relate generally to image processing, and more particularly, to noise adjustment in processed images. Some features may enable and provide improved image processing, including for low-light conditions.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Movement of subjects while capturing image frames (i.e., image frames for composition into a single still image, image frames for use as part of a video sequence) can create various distortions within the image frames. For example, movement of one or more objects within an image frame may cause the objects to blur and/or blend together or may leave motion artifacts within the captured image frame.

Digital image capture devices often contend with various types of noise that can affect the quality of the images they produce. Noise in digital images refers to random variations in brightness or color information, caused by factors such as sensor imperfections, low light levels, and electronic interference. Common types of noise include shot noise, thermal noise, and readout noise, which can manifest as graininess, speckles, or other visual artifacts within an image. These noise elements can obscure fine details and reduce the overall clarity of the captured image.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure relates to image processing techniques for enhancing low-light images captured by digital cameras. Specifically, these techniques involve adding adjusted residual noise back to denoised images to improve detail preservation and reduce artifacts. The process includes receiving multiple image frames, generating a first image and a map based on these frames, reducing noise in the first image to produce a second image, calculating a residual signal between the first and second images, adjusting the residual signal using the map, and combining the second image with the adjusted residual signal to produce an output image.

In one aspect, a method includes receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal.

In another aspect, a system includes a processor and a memory storing instructions which, when executed by the processor, cause the processor to perform operations including receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal.

In a further aspect, a non-transitory, computer-readable medium stores instructions which, when executed by a processor, cause the processor to perform operations including receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 depicts a system for noise adjustment in processed images according to some embodiments of the disclosure.

FIG. 4 shows a flow chart of an example method for processing image data to noise adjustment in processed images according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In low-light conditions, digital cameras often struggle with significant image noise due to factors like shot noise and readout noise inherent in the sensor. To mitigate this, image signal processors (ISPs) may employ machine learning-based denoisers, such as neural networks, to reduce noise levels in the captured images. These denoisers process images to produce cleaner outputs by minimizing the noise present in the raw sensor data.

However, existing denoising techniques can introduce new issues. One major problem is the occurrence of quantization artifacts or contouring in the processed images. This happens because ISPs typically operate at a fixed bit depth (e.g., 10-bit), while the raw sensor data might have a higher bit depth (e.g., 16-bit). The reduced bit depth limits the denoiser's ability to accurately represent subtle variations in intensity, leading to visible banding or contouring, especially in smooth gradient areas like skies or shadows.

Another issue with current denoisers is the loss of fine details and textures in low-frequency or uniform regions of the image. The denoising process may over-smooth these areas, resulting in images that appear unnatural or plasticky. This over-smoothing diminishes the visual quality of the image by removing essential details that contribute to the perception of realism.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

One solution to these problems is to introduce a noise addback method that reintroduces a portion of the residual noise removed during the denoising process back into the denoised image. The present techniques calculate a residual signal by determining the difference between the original image and the denoised image. This residual represents the fine details and textures lost during noise reduction. The residual signal may then be adjusted using a map, such as a motion map indicating regions of motion between image frames. By weighting the residual based on this map, the techniques ensure that less noise is added back in areas with motion, preventing reintroduction of motion-related artifacts. Additionally, a scaling factor is computed based on parameters like gain value (ISO settings) and pixel intensity. This scaling factor adjusts the amount of residual noise added back, decreasing it in conditions where noise would be more perceptible. Finally, the adjusted residual signal is combined with the denoised image to produce an output image that retains the benefits of noise reduction while preserving essential details and reducing artifacts like contouring.

Particular implementations of the subject matter described in this disclosure may be implemented to realize one or more of the following potential advantages or benefits. In some aspects, the present disclosure provides techniques for adding adjusted residual noise back to denoised low-light images, which may be particularly beneficial in enhancing image quality without introducing additional artifacts. For example, by reintroducing an adjusted portion of the residual noise, these techniques may reduce quantization artifacts and contouring issues caused by bit-depth limitations in image signal processors. This results in smoother gradients and preservation of subtle intensity variations.

Furthermore, the techniques may improve the preservation of fine details and textures that are often lost during aggressive noise reduction. This enhancement leads to images with a more natural and realistic appearance, improving the end-user experience, especially in low-light photography. By dynamically adjusting the residual noise based on factors like gain and pixel intensity, the techniques may optimize image quality across various shooting conditions.

Additionally, these techniques may improve the functioning of computing devices by integrating seamlessly into existing image processing pipelines with minimal computational overhead. This efficiency makes them suitable for real-time applications on devices like smartphones, where computational resources are limited but high-quality image processing is desired.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

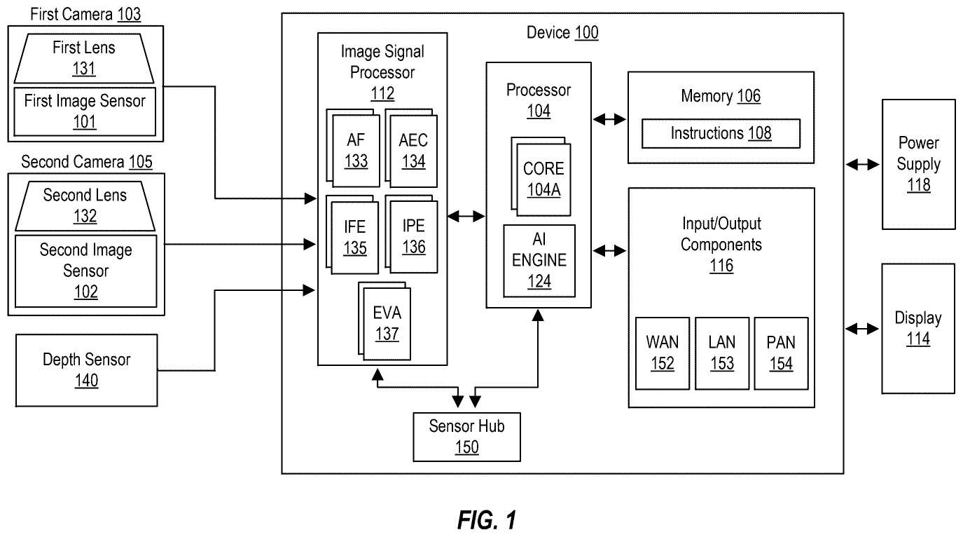

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise adjustment, image frame fusion, and residual determination operations. For example, execution of the instructions can instruct the image signal processor 112 to begin or end capturing an image frame or a sequence of image frames, in which the capture includes noise level adjustment as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

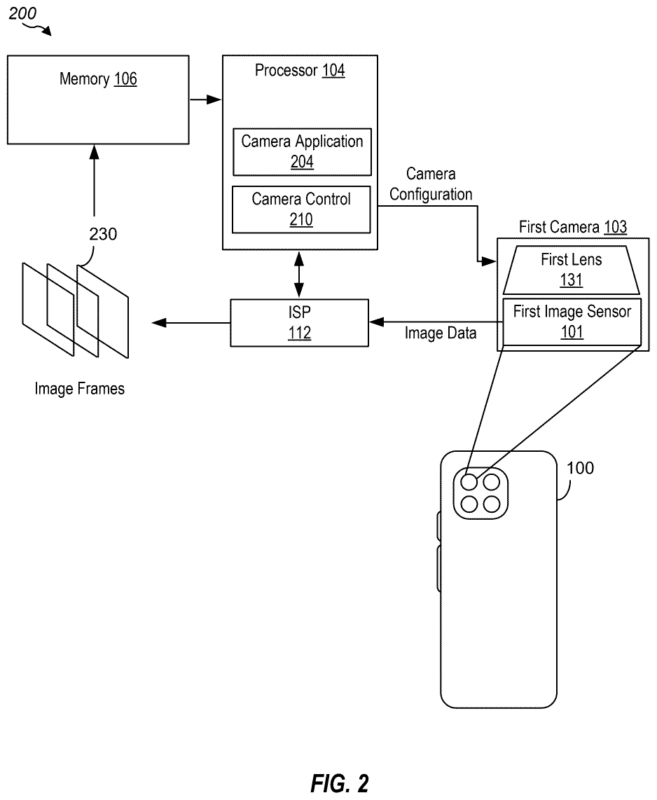

The exemplary image capture device of FIG. 1 may be operated to obtain improved images by adjusting the noise within images that have been fused, such as using temporal fusion. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

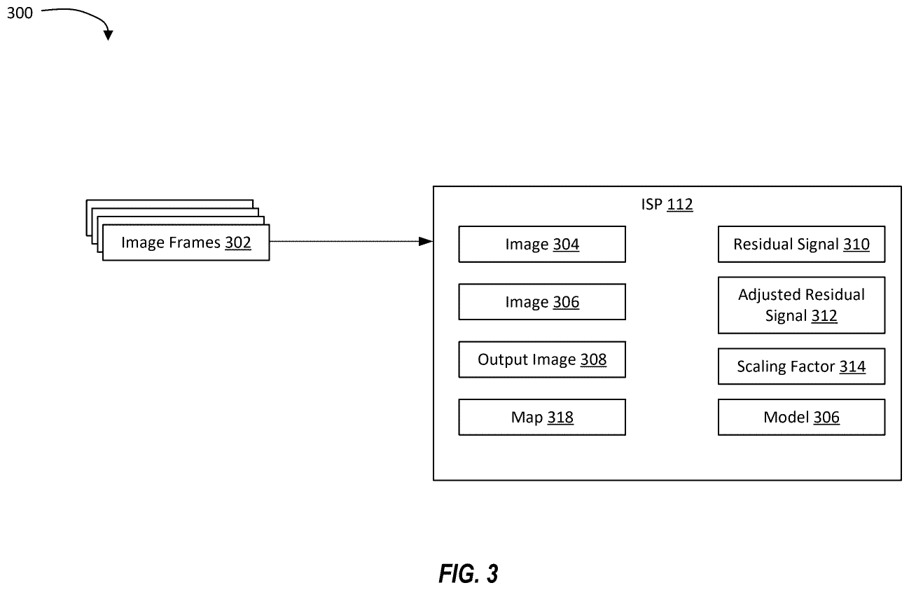

For example, FIG. 3 depicts a system 300 for noise adjustment of fused images according to some aspects of the present disclosure. The system 300 includes image frames 302 and the ISP 112. The ISP 112 contains a first image 304, a second image 306, an output image 308, a map 318, a residual signal 310, an adjusted residual signal 312, a scaling factor 314, and a machine learning model 316.

The image signal processor (ISP) 112 may be configured to receive a plurality of image frames 302 captured by the image sensors 101 and 102. These image frames 302 may be collected in low-light conditions, and may accordingly include increased sensor noise. Low-light conditions may include environments or scenes where the illumination levels are significantly lower than standard daylight conditions, such as less than 50 lux, 100 lux, 150 lux, 200 lux, and the like. Low-light conditions may include scenarios such as nighttime scenes, dimly lit indoor environments, or overcast days with minimal ambient light. In low-light conditions, sensor noise can be significantly higher, and may include both shot noise and readout noise. Shot noise arises from the discrete nature of light and the statistical variations in the arrival of photons at the sensor, leading to randomness in pixel intensity values. Readout noise originates from the electronic components of the sensor during the process of reading out the pixel values, introducing additional unwanted variations. For example, when capturing images of a dimly lit street at night or an indoor scene illuminated by candlelight, the limited available light results in fewer photons reaching the sensor. This scarcity of photons amplifies the effects of shot noise, causing noticeable graininess or speckling in the images. Readout noise becomes more prominent as the sensor's electronic amplification tries to boost the weak signals, further degrading image quality.

In particular, the ISP 112 may be configured to perform additional processing upon determining that image frames are captured in low-light conditions, such as all or part of the processing discussed herein. In certain implementations, the ISP 112 may be configured to determining at least one of the second image, the residual signal, the adjusted residual signal, or a combination thereof in response to determining that a measure of brightness in the first image is below a predetermined threshold, such as a predetermined brightness threshold. For example, the ISP 112 may analyze the first image 304 to calculate an average luminance value across all pixels. If the average luminance is below a threshold value (such as 100 on a scale of 0 to 255 where 0 represents black and 255 represents white) the ISP 112 may determine that the low-light processing techniques described herein are required and may determine at least one of the second image, the residual signal, the adjusted residual signal, or a combination thereof as discussed further herein.

In certain implementations, the image frames 302 may include image frames captured in a burst mode or other multi-frame image capture mode. Capturing multiple image frames 302 in a burst mode may improve the signal-to-noise ratio (SNR) in low-light conditions. In such instances, the ISP 112 may capture a rapid sequence of frames over a short period, leveraging temporal redundancy to mitigate random noise.

In particular, the ISP 112 may be configured to determine a first image 304 based on at least a subset of the plurality of image frames 302. By aggregating information from multiple frames, the ISP 112 may average out noise while reinforcing true image signal. In certain implementations, determining the first image 304 may involve performing a temporal fusion of the subset of image frames 302. Temporal fusion is a process where multiple frames captured over time are combined to create a single image with reduced noise and improved detail. In certain implementations, temporal fusion may include aligning the frames to compensate for any movement of the camera or subjects within the scene. For instance, in a scenario where eight consecutive frames are captured in quick succession, static elements in the scene will consistently align across frames, whereas random noise will vary. Consequently, averaging or otherwise combining these frames may enhance the overall image clarity and preserves important details that might be lost in a single noisy frame. In certain implementations, alignment of frames may be achieved through image registration techniques that match features or patterns across frames. The ISP 112 may utilize algorithms such as phase correlation, feature-based matching, or intensity-based methods to estimate the relative motion between frames and apply transformations to align them accurately. For example, features like corners, edges, or textures that are consistent across frames may be identified and used to compute alignment parameters. Once the frames are aligned, the ISP 112 may merge them using techniques such as multi-frame averaging or weighted blending. Multi-frame averaging involves computing the average pixel values across the aligned frames, which reduces random noise due to the averaging of uncorrelated noise components. Weighted blending may assign different weights to each frame based on criteria like exposure time, focus quality, or estimated noise levels, allowing the ISP 112 to optimize the fusion process by giving more importance to higher-quality frames.

The ISP 112 may be configured to determine a map 318 based on at least a subset of the plurality of image frames 302. Determining the map 318 may include generating a motion map that indicates regions of motion between at least two image frames from the subset of image frames 302. The motion map 318 may identify pixels or regions where differences occur due to movement of objects within the scene or movement of the camera itself. Motion detection between frames may be performed using methods like optical flow or block matching algorithms. Optical flow algorithms may estimate the pixel-wise motion between frames by analyzing the changes in intensity patterns. The ISP 112 may calculate motion vectors for each pixel or groups of pixels, indicating the direction and magnitude of movement. Block matching techniques may divide the image into blocks and searches for the matching block in the subsequent frame within a defined search area, computing motion vectors based on the best match.

Determining the motion map 318 may include determining both local motion, representing motion of objects within the scene, and global motion, representing movement of the imaging device capturing the frames. The ISP 112 may estimate global motion by analyzing the overall shift or rotation of the entire image content between frames, often due to camera shake or intentional panning. In contrast, local motion may identified by detecting movements of individual objects or subjects within the scene. The ISP 112 may aggregate the local motion and global motion to form the motion map 318. The map 318 may thus reflect both the camera-induced and object-induced movements.

The ISP 112 may be configured to determine a second image 306 by reducing noise in the first image 304. In certain implementations, the ISP 112 processes the first image 304 using a machine learning model 316 trained to reduce image noise. The machine learning model 316 may be a neural network specifically designed for image denoising. In certain implementations, the machine learning model may be implemented as a neural network, such as a convolutional neural network (CNN), that is trained to reduce image noise. In particular implementations, the ISP 112 may provide the first image 304 and the map 318 to the machine learning model 316 for use in determining the second image 306. The motion map 318 may be used by the machine learning model 316 to adjust noise reduction in different regions of the image 304. For example, the model 316 may apply stronger noise reduction in static regions indicated by the motion map 318 and less aggressive noise reduction in areas with detected motion.

In certain implementations, the first image 304 and the second image 306 are represented with a first bit depth, such as 10 bits per channel, while the plurality of image frames 302 have a second bit depth greater than the first bit depth, such as 16 bits per channel. Additionally, the machine learning model 316 may operate on image data represented with a third bit depth less than the first bit depth, such as 10 bits per channel. Reducing the bit depth for processing by the neural network can enhance computational efficiency and meet hardware limitations within the However, as noted above, this reduction in bit depth may introduce quantization errors and result in the loss of subtle intensity variations and fine details.

The ISP 112 may be configured to determine a residual signal 310 based on the first image 304 and the second image 306. In certain implementations, the residual signal 310 includes differences between corresponding pixel values of the first image 304 and the second image 306. For example, the residual signal 310 may be determined as Residual Signal 310=First Image 304−Second Image 306.

In such implementations, each pixel value in the residual signal 310 may be computed by subtracting the pixel value of the second image 306 from the corresponding pixel value of the first image 304. The residual signal 310 may accordingly represent both the noise removed by the denoising process and any fine details or textures that may have been lost during noise reduction. For example, textures in low-frequency areas like walls or the sky, subtle gradients in illumination, and fine edges of objects may be diminished in the denoised second image 306. By analyzing the residual signal 310, the ISP 112 identifies these lost details for potential reintroduction.

In certain implementations, preprocessing or filtering may be applied to the residual signal 310 to focus on meaningful details while suppressing unwanted noise. For example, the ISP 112 may use a predetermined threshold to restrict the residual signal to differences that exceed the predetermined threshold.

The ISP 112 may further determine an adjusted residual signal 312 based on the residual signal 310 and the map 318. In certain implementations, determining the adjusted residual signal 312 may include weighting the residual signal 310 based on the map 318. The map 318, which indicates regions of motion, may be used to modulate the contribution of the residual signal 310 across different areas of the image. For example, the adjusted residual signal 312 may be determined as Adjusted Residual Signal 312=Residual Signal 310×Map 318. In such instances, the map 318 may contain values ranging from 0 to 1 for each pixel (or may be normalized to contain values from 0 to 1) where a value of 0 represents areas of high motion and a value of 1 represents static regions. By multiplying the residual signal 310 by the map 318, the ISP 112 attenuates the residual contributions in areas with significant motion, which may reduce or avoid reintroducing noise or artifacts in regions where motion could cause blurring or ghosting. For example, if a moving car is present in the scene, the motion map 318 may indicate lower values to the pixels corresponding to the car. Consequently, the adjusted residual signal 312 will have reduced values in those areas, minimizing the impact of motion on the final image. In contrast, static regions like buildings or stationary objects will retain higher residual values, allowing for the enhancement of fine details in those areas.

The ISP 112 may determine an output image 308 by combining the second image 306 and at least a portion of the adjusted residual signal 312. In certain implementations, this combination may include scaling the adjusted residual signal 312 by a scaling factor 314 before adding the adjusted residual signal to the second image 306.

In certain implementations, the ISP 112 may determine the scaling factor 314 based on at least one of a gain value and pixel intensity values associated with the first image 304. The gain value may correspond to an ISO setting of the image sensor used to capture the plurality of image frames 302. In particular, sensor gain (ISO) may directly relate to noise levels in captured images, where higher gain settings amplify not only the signal but also the sensor noise. As the gain increases, the amount of noise in the image becomes more pronounced, which can be accounted for within the scaling factor 314. In certain implementations, the scaling factor 314 is computed as a function of the gain value, wherein the scaling factor decreases as the gain value increases. For example, the scaling factor 314 may be determined as:

$$Scaling Factor 314 = a \times ( 1 - \frac{Gain}{Max Gain} ) + b ,$$

where:
a is a tuning parameter that controls the overall contribution of the residual signal,
Gain is the current ISO gain setting of the image sensor,
MaxGain is the maximum possible gain value for the sensor, and
b is a baseline offset parameter.

One or more of these parameters may be adjusted based on characteristics of the imaging device, such as sensor noise profiles and dynamic range capabilities. In particular, the parameters may be tuned during calibration to optimize image quality. In the above implementation, the parameter ‘a’ may adjust the extent to which the scaling factor decreases with increasing gain, effectively controlling how much residual detail is added back at different gain levels. In certain implementations, the parameter ‘b’ provides a floor for the scaling factor, ensuring that some degree of detail enhancement is maintained even at high gain settings. For example, if a is set to 0.1 and b is set to 0.02, the scaling factor 314 decreases from 0.12 to 0.02 as the gain increases from 0 to MaxGain.

Different characteristics of the imaging device, such as the sensor's inherent noise level, sensitivity, and dynamic range, may require adjustments to the parameters ‘a’ and ‘b’. For example, a sensor with a higher noise profile might utilize a lower ‘a’ value to prevent excessive noise reintroduction, while a sensor with a wider dynamic range might employ a higher ‘a’ value to enhance detail preservation. Similarly, the baseline offset ‘b’ may be set higher for devices with poorer low-light performance to ensure that some detail is always reintroduced, regardless of the gain setting.

In additional or alternative implementations, the scaling factor 314 may be computed based on both the gain value and pixel intensity values of the first image 304. For example, the scaling factor may be determined as:

$$Scaling Factor 314 = a \times ( 1 - \frac{Gain}{Max Gain} ) \times ( 1 - \frac{Intensity}{Max Intensity} ) ,$$

where
Intensity represents the pixel intensity values in the first image 304, and
MaxIntensity is the maximum possible pixel intensity value (e.g., 255 for 8-bit images).

This formula ensures that the scaling factor 314 decreases as either the gain value increases or the pixel intensity values increase. Considering pixel intensity may allow the ISP 112 to add less noise in brighter areas where noise is less perceptible and unnecessary, while allowing more detail enhancement in darker regions where it is needed most. As noted above, one or more of the parameters for determining the scaling factor 314 may be adjusted based on characteristics of the imaging device. In the above implementation, the ‘a’ influences the overall scaling, while the dependencies on Gain and Intensity ensure that less residual is added back in brighter areas or at higher gain levels. For instance, with ‘a’ set to 0.1, and when both Gain and Intensity are at 50% of their maximum values, the scaling factor 314 may calculate to approximately 0.025.

Additionally, in various implementations, the parameters (such as ‘a’, ‘b’, or a combination thereof) may be adjusted based on different shooting conditions to further optimize image quality. For example, in extremely low-light environments where the Gain approaches its maximum value, ‘a’ might be reduced to minimize the scaling factor 314 and prevent adding excessive noise. Conversely, in moderately low-light conditions with lower Gain values, ‘a’ can be increased to allow more residual detail to be reintroduced. As another example, in scenes with high ambient light but low contrast, adjusting ‘a’ and ‘b’ may help balance the enhancement of fine details without over-amplifying noise.

In certain implementations, the ISP 112 may adjust the scaling factor 314 dynamically based on detected shooting conditions, such as ambient lighting levels, motion intensity within the scene, and specific characteristics of different image sensors on the same device. For instance, ambient light sensors or exposure settings can inform the ISP 112 about current lighting conditions, prompting real-time adjustments to the scaling factor 314 to appropriately balance noise reduction and detail preservation. Additionally, different cameras or image sensors on the same device may have distinct parameter settings for ‘a’ and ‘b’ due to variations in sensor characteristics. For example, a device equipped with both wide-angle and telephoto lenses may calibrate the scaling factor parameters separately for each sensor to account for differences in noise performance and optical properties.

In certain implementations, combining the second image 306 and the adjusted residual signal may include scaling the adjusted residual signal 312 by the scaling factor 314 and adding the result to the second image 306 to produce the output image 308. For example, the output image 308 may be determined as: Output Image 308=Second Image 306+(Scaling Factor 314×Adjusted Residual Signal 312).

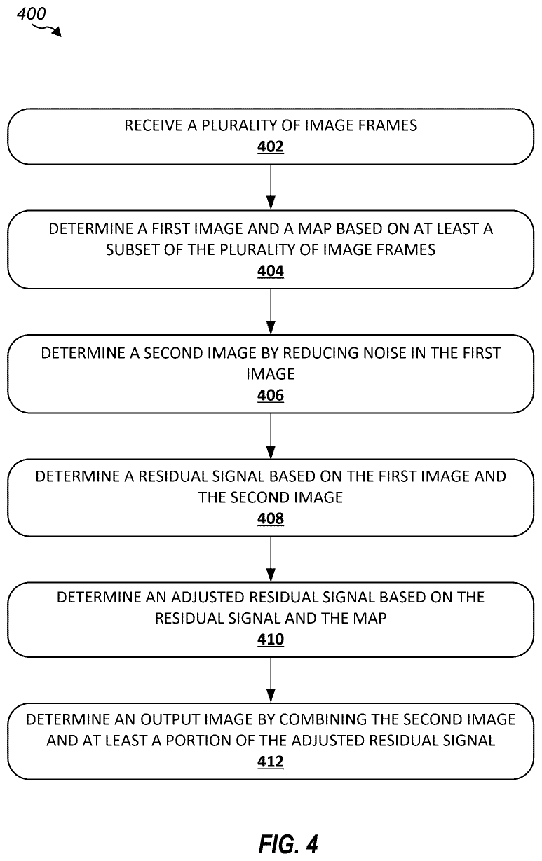

The system 200 of FIG. 2 may be configured to perform the operations described with reference to FIG. 3 to determine output image frames 230. FIG. 4 shows a flow chart of an example method for processing image data to adjust noise in low-light images according to some aspects of the disclosure. The capturing in FIG. 4 may obtain an improved digital representation of a scene, which results in a photograph or video with higher image quality (IQ).

At block 402, the method 400 includes receiving a first image. For example, the ISP 112 may receive the first image 304. In certain implementations, the method 400 may include determining the first image by performing a temporal fusion of at least the subset of a plurality of image frames, such as image frames 302 captured by the image sensors 101 and 102. In certain implementations, the plurality of image frames are captured in low-light conditions. In certain implementations, at least one of the second image, the residual signal, the adjusted residual signal, or a combination thereof is determined in response to determining that a measure of brightness in the first image 304 is below a predetermined threshold. The image frames 302 may be received at ISP 112, processed through an image front end (IFE) and/or an image post-processing engine (IPE) of the ISP 112, and stored in memory. In some implementations, the capture of image data may be initiated by a camera application executing on the processor 104, which causes camera control 210 to activate capture of image data by the camera 103, and cause the image data to be supplied to a processor, such as processor 104 or ISP 112.

At block 404, the method 400 includes determining a map based on the first image. For example, the ISP 112 may determine the map 318 based on the first image 304.

At block 404, the method 400 includes determining a first image and a map 318 based on at least a subset of the plurality of image frames. For example, the ISP 112 may determine the first image 304 and the map 318 based on at least a subset of the image frames 302. In certain implementations, determining the first image includes performing a temporal fusion of at least the subset of the plurality of image frames. Additionally, determining the map may involve determining a motion map between at least two image frames from the subset. In certain implementations, the motion map 318 indicates regions of motion between the at least two image frames.

At block 406, the method 400 includes determining a second image by reducing noise in the first image. For example, the ISP 112 may determine the second image 306 by reducing noise in the first image 304. In certain implementations, determining the second image includes processing the first image with a machine learning model 316 trained to reduce image noise. In certain implementations, the machine learning model 316 is a neural network.

At block 408, the method 400 includes determining a residual signal based on the first image and the second image. For example, the ISP 112 may determine the residual signal 310 based on the first image 304 and the second image 306. In certain implementations, the residual signal 310 comprises differences between corresponding pixel values of the first image 304 and the second image 306.

At block 410, the method 400 includes determining an adjusted residual signal based on the residual signal and the map. For example, the ISP 112 may determine the adjusted residual signal 312 based on the residual signal 310 and the map 318. In certain implementations, determining the adjusted residual signal 312 includes weighting the residual signal 310 based on the map 318. In certain implementations, weighting the residual signal 310 reduces contributions from regions of the residual signal 310 corresponding to areas of motion indicated by the map 318.

At block 412, the method 400 includes determining an output image by combining the second image and at least a portion of the adjusted residual signal. For example, the ISP 112 may determine the output image 308 by combining the second image 306 and at least a portion of the adjusted residual signal 312. In certain implementations, the method 400 further includes determining a scaling factor 314 based on at least one of a gain value and pixel intensity values associated with the first image 304. In certain implementations, the gain value corresponds to an ISO setting of an image sensor used to capture the plurality of image frames 302. In certain implementations, determining the scaling factor 314 includes computing the scaling factor as a function of the gain value, where the scaling factor decreases as the gain value increases. In certain implementations, computing the scaling factor 314 further includes applying a baseline offset to ensure the scaling factor remains above a minimum threshold. In certain implementations, determining the scaling factor 314 includes determining the scaling factor 314 based on both the gain value and pixel intensity values of the first image 304, where the scaling factor 314 decreases as either the gain value increases or the pixel intensity values increase. In certain implementations, combining the second image 306 and at least a portion of the adjusted residual signal 312 includes scaling the adjusted residual signal 312 by the scaling factor 314 and adding the scaled adjusted residual signal to the second image 306 to produce the output image 308.

In one or more aspects, techniques for supporting image processing may include additional aspects, such as any single aspect or any combination of aspects described below or in connection with one or more other processes or devices described elsewhere herein. In a first aspect, a method includes receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal.

In a second aspect according to the first aspect, the plurality of image frames are captured in low-light conditions.

In a third aspect according to any one of the first through second aspects, determining the first image includes performing a temporal fusion of at least the subset of the plurality of image frames.

In a fourth aspect according to any one of the first through third aspects, the residual signal includes differences between corresponding pixel values of the first image and the second image.

In a fifth aspect according to any one of the first through fourth aspects, determining the adjusted residual signal includes weighting the residual signal based on the map.

In a sixth aspect according to the fifth aspect, weighting the residual signal reduces contributions from regions of the residual signal corresponding to areas of motion within the first image indicated by the map.

In a seventh aspect according to any one of the first through sixth aspects, the method further includes determining a scaling factor based on at least one of a gain value and pixel intensity values associated with the first image.

In an eighth aspect according to the seventh aspect, the gain value corresponds to an ISO setting of an image sensor used to capture the plurality of image frames.

In a ninth aspect according to any of the seventh and eighth aspects, determining the scaling factor includes computing the scaling factor as a function of the gain value, wherein the scaling factor decreases as the gain value increases.

In a tenth aspect according to any of the seventh through ninth aspects, determining the scaling factor includes computing the scaling factor based on the gain value and pixel intensity values of the first image, wherein the scaling factor decreases as either the gain value increases or the pixel intensity values increase.

In an eleventh aspect according to any of the seventh through tenth aspects, combining the second image and at least a portion of the adjusted residual signal includes scaling the adjusted residual signal by the scaling factor and adding the scaled adjusted residual signal to the second image to produce the output image.

In a twelfth aspect according to any one of the first through eleventh aspects, the first image and the second image are represented with a first bit depth, and the plurality of image frames have a second bit depth greater than the first bit depth.

In a thirteenth aspect, a system includes a processor and a memory storing instructions which, when executed by the processor, cause the processor to perform operations including receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal. Additionally, the system may perform or operate according to one or more aspects as described below. In some implementations, the system includes a wireless device, such as a UE. In some implementations, the system includes a remote server, such as a cloud-based computing solution, which receives image data for processing to determine output image frames. In some implementations, the system may include at least one processor, and a memory coupled to the processor. The processor may be configured to perform operations described herein with respect to the system. In some other implementations, the system may include a non-transitory computer-readable medium having program code recorded thereon and the program code may be executable by a computer for causing the computer to perform operations described herein with reference to the system. In some implementations, the system may include one or more means configured to perform operations described herein. In some implementations, a method of wireless communication may include one or more operations described herein with reference to the system.

In a fourteenth aspect according to the thirteenth aspect, the plurality of image frames are captured in low-light conditions.

In a fifteenth aspect according to any one of the thirteenth through fourteenth aspects, determining the first image includes performing a temporal fusion of at least the subset of the plurality of image frames.

In a sixteenth aspect according to any one of the thirteenth through fifteenth aspects, the residual signal includes differences between corresponding pixel values of the first image and the second image.

In a seventeenth aspect according to any one of the thirteenth through sixteenth aspects, the operations further include determining a scaling factor based on at least one of a gain value and pixel intensity values associated with the first image.

In an eighteenth aspect according to the seventeenth aspect, determining the scaling factor includes computing the scaling factor as a function of the gain value, wherein the scaling factor decreases as the gain value increases.

In a nineteenth aspect according to any one of the thirteenth through eighteenth aspects, determining the adjusted residual signal includes weighting the residual signal based on the map.

In a twentieth aspect, a non-transitory, computer-readable medium stores instructions which, when executed by a processor, cause the processor to perform operations including receiving a plurality of image frames, determining a first image and a map based on at least a subset of the plurality of image frames, determining a second image by reducing noise in the first image, determining a residual signal based on the first image and the second image, determining an adjusted residual signal based on the residual signal and the map, and determining an output image by combining the second image and at least a portion of the adjusted residual signal.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIG. 4 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method comprising:
receiving a first image;
determining a map based on the first image;
determining a second image by reducing noise in the first image;
determining a residual signal based on the first image and the second image;
determining an adjusted residual signal based on the residual signal and the map;
determining an output image by combining the second image and at least a portion of the adjusted residual signal.

2. The method of claim 1, wherein at least one of the second image, the residual signal, the adjusted residual signal, or a combination thereof is determined in response to determining that a measure of brightness in the first image is below a predetermined threshold.

3. The method of claim 1, further comprising determining the first image by performing a temporal fusion of at least the subset of a plurality of image frames.

4. The method of claim 1, wherein the residual signal comprises differences between corresponding pixel values of the first image and the second image.

5. The method of claim 1, wherein determining the adjusted residual signal comprises weighting the residual signal based on the map.

6. The method of claim 5, wherein weighting the residual signal reduces contributions from regions of the residual signal corresponding to areas of motion within the first image indicated by the map.

7. The method of claim 1, further comprising determining a scaling factor based on at least one of a gain value and pixel intensity values associated with the first image.

8. The method of claim 7, wherein the gain value corresponds to an ISO setting of an image sensor used to capture the plurality of image frames.

9. The method of claim 7, wherein determining the scaling factor comprises computing the scaling factor as a function of the gain value, wherein the scaling factor decreases as the gain value increases.

10. The method of claim 7, wherein determining the scaling factor comprises computing the scaling factor based on the gain value and pixel intensity values of the first image, wherein the scaling factor decreases as either the gain value increases or the pixel intensity values increase.

11. The method of claim 7, wherein combining the second image and at least a portion of the adjusted residual signal comprises:
scaling the adjusted residual signal by the scaling factor; and
adding the scaled adjusted residual signal to the second image to produce the output image.

12. The method of claim 1, wherein the first image and the second image are represented with a first bit depth, and wherein the plurality of image frames have a second bit depth greater than the first bit depth.

13. A system comprising:
a processor; and
a memory storing instructions which, when executed by the processor, cause the processor to perform operations including:
receiving a first image;
determining a map based on the first image;
determining a second image by reducing noise in the first image;
determining a residual signal based on the first image and the second image;
determining an adjusted residual signal based on the residual signal and the map;
determining an output image by combining the second image and at least a portion of the adjusted residual signal.

14. The system of claim 13, wherein at least one of the second image, the residual signal, the adjusted residual signal, or a combination thereof is determined in response to determining that a measure of brightness in the first image is below a predetermined threshold.

15. The system of claim 13, further comprising determining the first image by performing a temporal fusion of at least the subset of a plurality of image frames.

16. The system of claim 13, wherein the residual signal comprises differences between corresponding pixel values of the first image and the second image.

17. The system of claim 13, further comprising determining a scaling factor based on at least one of a gain value and pixel intensity values associated with the first image.

18. The system of claim 17, wherein determining the scaling factor comprises computing the scaling factor as a function of the gain value, wherein the scaling factor decreases as the gain value increases.

19. The system of claim 13, wherein determining the adjusted residual signal comprises weighting the residual signal based on the map.

20. A non-transitory, computer-readable medium storing instructions which, when executed by a processor, cause the processor to perform operations comprising:
receiving a first image;
determining a map based on the first image;
determining a second image by reducing noise in the first image;
determining a residual signal based on the first image and the second image;
determining an adjusted residual signal based on the residual signal and the map;
determining an output image by combining the second image and at least a portion of the adjusted residual signal.
